(19) United States
(12) Patent Application Publication
(10) Pub. No.: US 2025/0380017 A1
(43) Pub. Date: Dec. 11, 2025

(54) TRANSFORMATION AND STREAMING OF IMMERSIVE VIDEO

(71) Applicant: SpaceVibes Inc., Santa Barbara, CA (US)

(72) Inventors: Amanda Besemer Sampson, Lincoln, NE (US); Rafal Kopiec, Vilni (LT); Eugene Pentland, Lincoln, NE (US)

(21) Appl. No.: 19/230,898

(22) Filed: Jun. 6, 2025

Related U.S. Application Data
(60) Provisional application No. 63/657,948, filed on Jun. 9, 2024.

(51) Int. Cl. H04N 21/262; H04N 21/2343; H04N 21/414; H04N 21/858

(52) U.S. Cl. CPC H04N 21/26258; H04N 21/2343; H04N 21/41407; H04N 21/8586

(57) ABSTRACT

A system and method are disclosed for receiving video in a first format from a first client device, transforming the video into a second format, transmitting the video in the second format to one or more other client devices, and displaying the video in the second format on the one or more other client devices.

### PRIORITY CLAIM

This application claims priority to U.S. Provisional Patent Application No. 63/657,948, filed on Jun. 9, 2024, and titled, “System and Method for Immersive 3D and Spatial Streaming,” which is incorporated by reference herein.

### TECHNICAL FIELD

Numerous embodiments are disclosed for transforming immersive video from a first format into a second format and streaming the video in the second format to a plurality of client devices.

### BACKGROUND OF THE INVENTION

The prior art includes spatial computers such as the spatial computers associated with the trademarks “APPLE VISION PRO” and “META QUEST”. These spatial computers can comprise one or more cameras for capturing immersive video (which is video that surrounds the viewer in 180 degrees, 360 degrees, or an amount between 180 and 360 degrees), headgear that includes an immersive display to display immersive video to the user, and a network interface for uploading and downloading immersive video and other data. These spatial computers can be used to generate a virtual reality (VR), augmented reality (AR), or XR (extended reality) environment for the user using the immersive display. However, these prior art devices currently are unable to support many existing immersive video formats. Moreover, existing streaming technologies do not adequately support immersive video and often result in poor video quality and limited interactivity for the user.

What is needed is an improved system and method for transmitting immersive video from one device to another.

### SUMMARY OF THE INVENTION

A system and method are disclosed for receiving video in a first format from a first client device, transforming the video into a second format, transmitting the video in the second format to one or more other client devices, and displaying the video in the second format on the one or more other client devices.

The system achieves dramatically faster loading times for high-resolution immersive content compared to prior art systems while maintaining 100% native quality with zero perceptible loss. While traditional spatial computers require 30-45 minutes to load 20 GB MV-HEVC files at 8K+ resolution (180° and 360° immersive video), the embodiments described herein achieve loading times of 3.6 seconds or less through innovative micro-segmentation, progressive composition, and parallel transformation techniques, representing a performance improvement exceeding 500× over existing solutions without any compromise to visual fidelity. Unlike prior art systems that require complete file download before playback, the embodiments enable true streaming of both live and pre-recorded immersive content at native quality, eliminating the need to choose between quality and immediate access.

### BRIEF DESCRIPTION OF THE DRAWINGS

FIG. 1 depicts hardware components of a client device.

FIG. 2 depicts software components of a client device.

FIG. 3 depicts hardware components of a server.

FIG. 4 depicts software components of a server.

FIG. 5 depicts a system comprising a plurality of servers and a plurality of client devices.

FIG. 6 depicts software modules executed by a server.

FIG. 7 depicts optional software modules within a control module executed by a server.

FIGS. 8A, 8B, and 8C depict an example of an interactive experience enabled by a user interaction module.

FIG. 9 depicts a user interaction module.

FIG. 10 depicts a dynamic software generation method.

FIGS. 11A, 11B, 11C, 11D, and 11E depict screenshots generated on a client device during an example implementation of dynamic software generation method.

FIG. 12 depicts an example implementation of one of the steps of the dynamic software generation method.

FIG. 13 depicts a loading time comparison between prior art systems and the embodiments for 20 GB MV-HEVC immersive video files at 8K+ resolution.

FIG. 14 depicts the VR/AR device-agnostic architecture of the embodiments.

FIG. 15 depicts the difference between the streaming approach of the embodiments and the download-first approach of prior art systems.

### DETAILED DESCRIPTIONS OF THE PREFERRED EMBODIMENTS

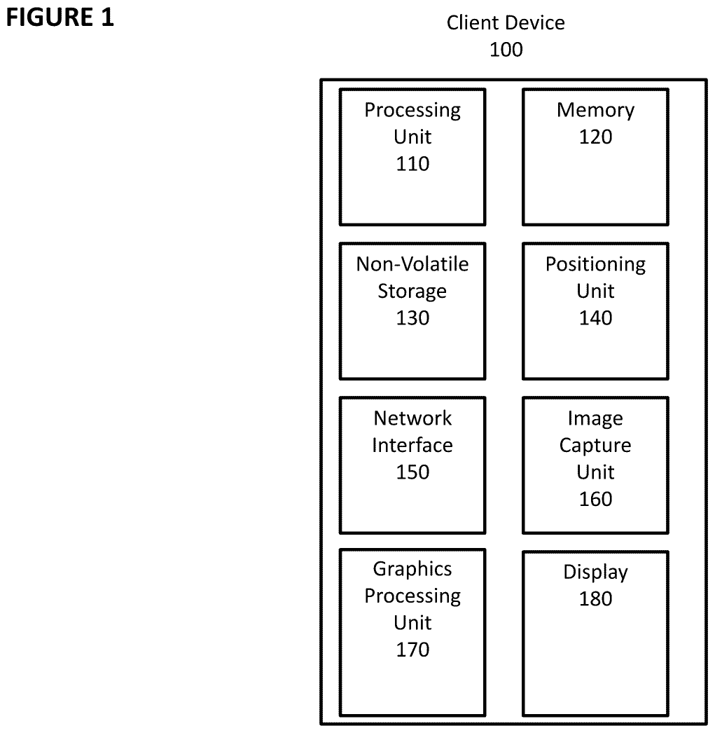

FIG. 1 depicts hardware components of client device 100, which is a computing device that can: (1) capture and/or display immersive video, such as a spatial computer (such as the products associated with the trademarks “APPLE VISION PRO” and “META QUEST”), gaming unit, wearable computing device such as a watch or glasses, holographic device, smart contact lenses, or any other computing device that can capture and/or display immersive video; and/or (2) capture and display non-immersive video, such as a laptop, desktop, mobile phone, tablet, or server. Client device 100 comprises processing unit 110, memory 120, non-volatile storage 130, positioning unit 140, network interface 150, image capture unit 160, graphics processing unit 170, and display 180.

Processing unit 110 optionally comprises a microprocessor with one or more processing cores that can execute instructions. Memory 120 optionally comprises DRAM or SRAM volatile memory. Non-volatile storage 130 optionally comprises a hard disk drive or flash memory array. Positioning unit 140 optionally comprises a GPS unit or GNSS unit that communicates with GPS or GNSS satellites to determine latitude and longitude coordinates for client device 100, usually output as latitude data and longitude data, and/or an ultra-wideband chip (also known as a U1 or U2 chip) that can determine distance and direction of other devices containing an ultra-wideband chip. Network interface 150 optionally comprises a wired interface (e.g., Ethernet interface) or wireless interface (e.g., 3G, 4G, 5G, GSM, 802.11, protocol known by the trademark “BLUETOOTH,” etc.). Image capture unit 160 comprises one or more cameras that optionally can capture immersive or non-immersive video. Graphics processing unit (also known as a GPU) 170 optionally comprises one or more processor cores for generating graphics, including immersive video, for display, and for performing mathematical calculations such as those performed by an artificial intelligence (AI) engine. Display 180 optionally can display immersive or non-immersive video generated by graphics processing unit 170, and optionally comprises a headset, monitor, touchscreen, or other type of immersive display, and/or a non-immersive display.

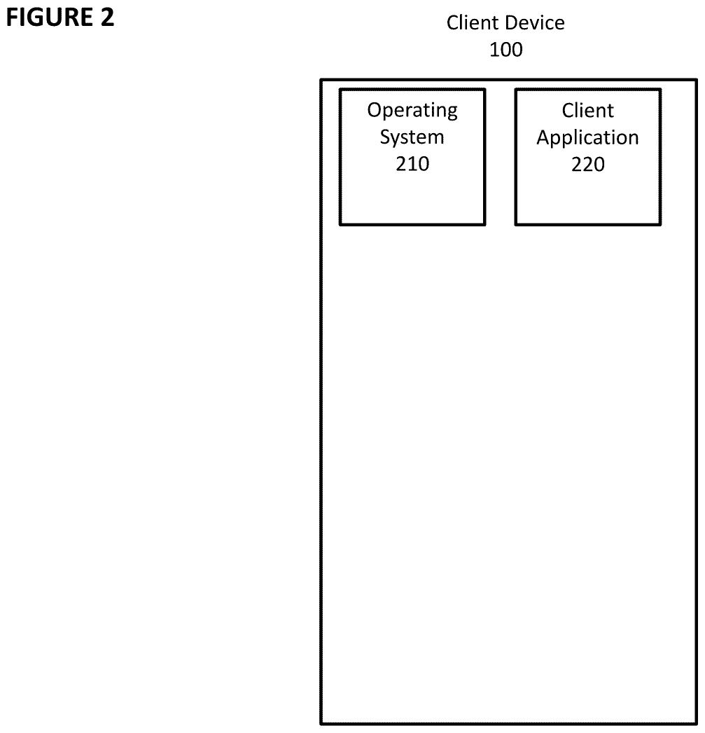

FIG. 2 depicts software components of client device 100. Client device 100 comprises operating system 210 (such as the operating systems known by the trademarks “VISIONOS,” “WINDOWS,” “LINUX,” “ANDROID,” “IOS,” or other operating system) and client application 220. Client application 220 comprises lines of software code executed by processing unit 110 and/or graphics processing unit. Client application 220 can perform certain aspects of the embodiments described herein.

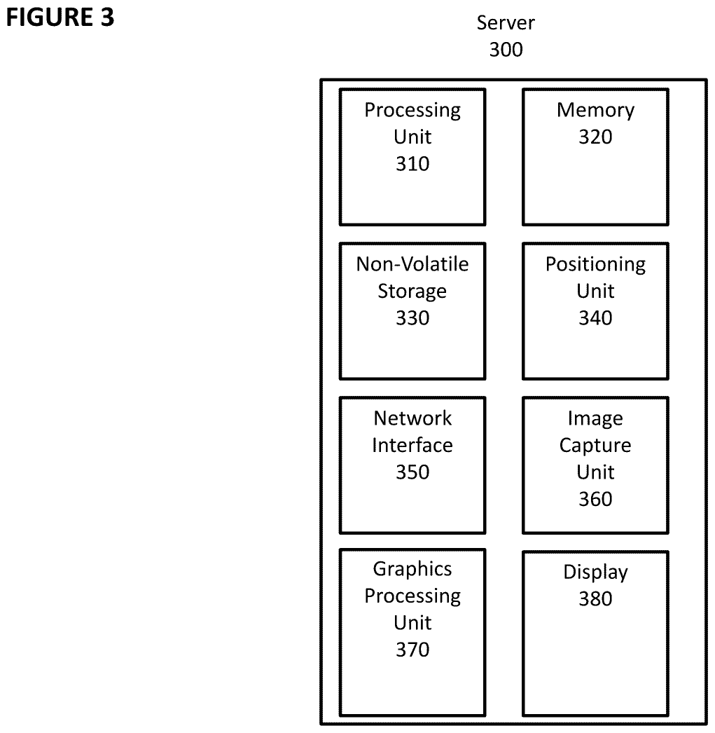

FIG. 3 depicts hardware components of server 300. Server 300 is a computing device that comprises processing unit 310, memory 320, non-volatile storage 330, positioning unit 340, network interface 350, image capture unit 360, graphics processing unit 370, and display 380.

Processing unit 310 optionally comprises a microprocessor with one or more processing cores that can execute instructions. Memory 320 optionally comprises DRAM or SRAM volatile memory. Non-volatile storage 330 optionally comprises a hard disk drive or flash memory array. Positioning unit 340 optionally comprises a GPS unit or GNSS unit that communicates with GPS or GNSS satellites to determine latitude and longitude coordinates for server 300, usually output as latitude data and longitude data and/or an ultra-wideband chip (also known as a U1 or U2 chip) that can determine distance and direction of other devices containing an ultra-wideband chip. Network interface 350 optionally comprises a wired interface (e.g., Ethernet interface) or wireless interface (e.g., 3G, 4G, 5G, GSM, 802.11, protocol known by the trademark “Bluetooth,” etc.). Image capture unit 160 comprises one or more cameras that optionally can capture immersive or non-immersive video. Graphics processing unit (also known as a GPU) 170 optionally comprises one or more processor cores for generating graphics, including immersive video, for display, and for performing mathematical calculations such as those performed by an artificial intelligence (AI) engine. Display 180 optionally can display immersive or non-immersive video generated by graphics processing unit 170, and optionally comprises a headset and monitor.

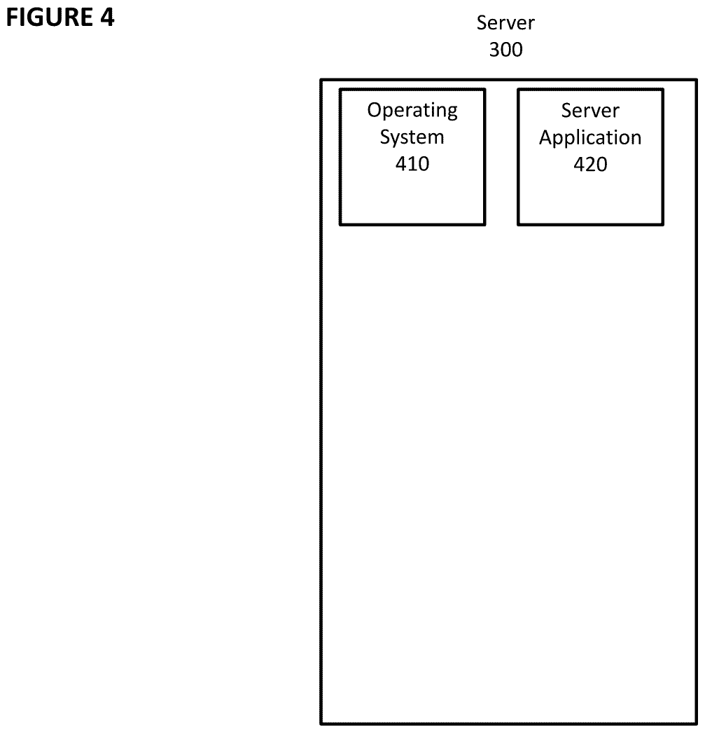

FIG. 4 depicts software components of server 300. Server 300 comprises operating system 410 (such as the server operating systems known by the trademarks “WINDOWS SERVER,” “MAC OS X SERVER,” “LINUX,” or others) and server application 420. Server application 420 comprises lines of software code executed by processing unit 310 and/or graphics processing unit 370, and server application 420 is designed specifically to interact with client application 220. Server application 420 performs certain aspects of the embodiments described herein.

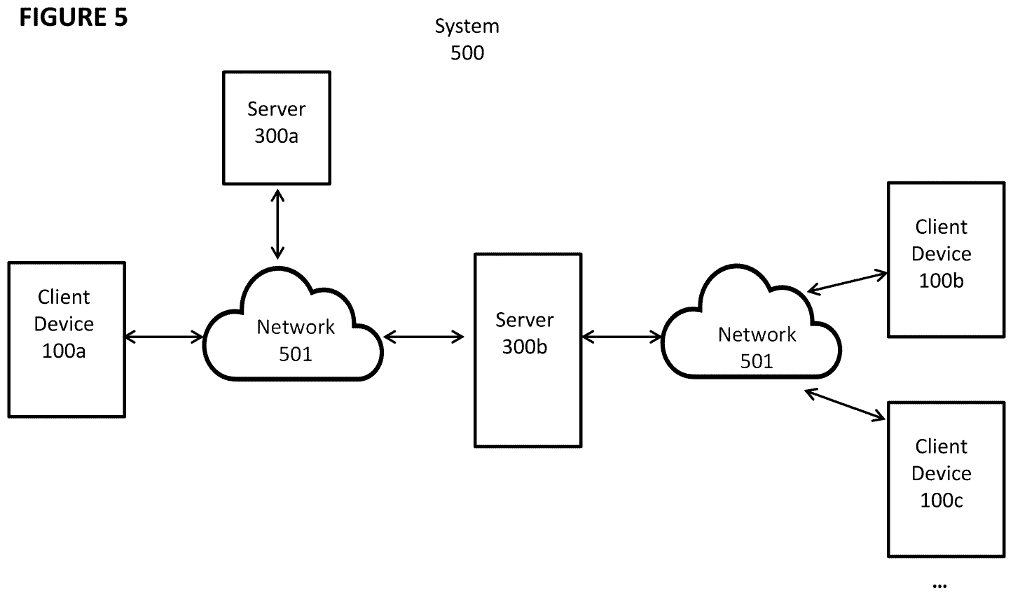

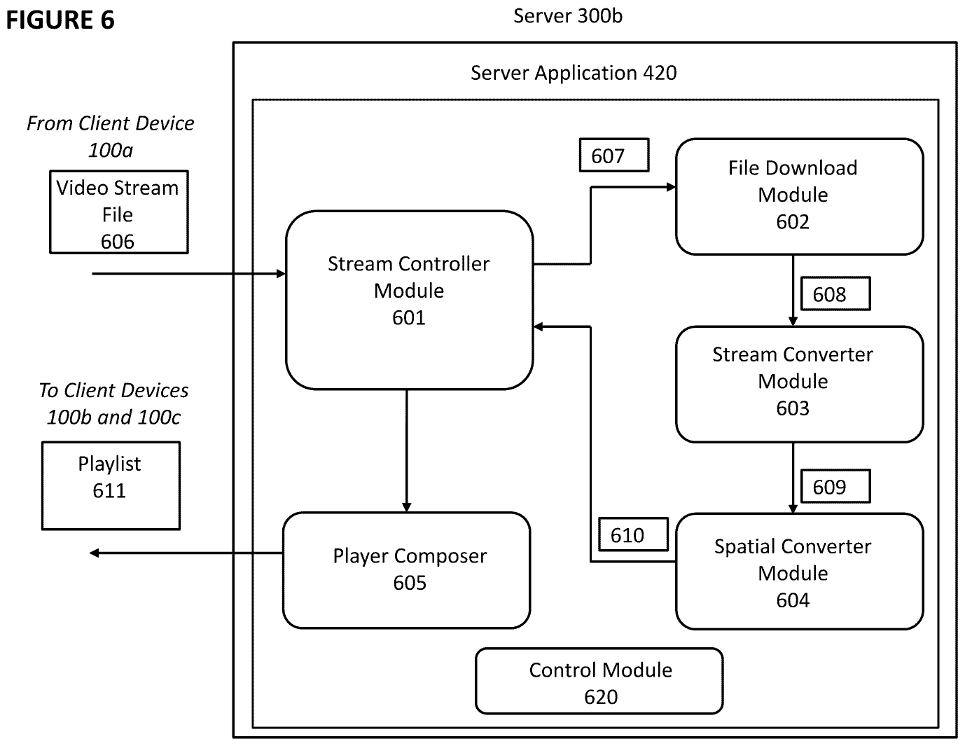

FIG. 5 depicts exemplary system 500, which comprises client devices 100a, 100b, and 100c; servers 300a and 300b; and network 501. Servers 300a and 300b are instantiations of server 300. In this example, server 300a is an HTTP live streaming server and may not include server application 420. Client devices 100a, 100b, and 100c are instantiations of client device 100. Client devices 100a, 100b, and 100c and servers 300a and 300b communicate with one another over network 501 using their respective network interfaces 150 and 350 to perform the functions described below with reference to FIGS. 6-12. These are exemplary devices, and it is to be understood that any number of different instantiations of client device 100 and server 300 can be used.

FIG. 6 depicts an embodiment of server application 420 operated by server 300b. Server application 420 comprises stream controller module 601, file download module 602, stream converter module 603, spatial converter module 604, player composer 605, and control module 620. Stream controller module 601, file download module 602, stream converter module 603, spatial converter module 604, player composer 605, and control module 620 each comprises lines of software code executed by one or more of processing unit 310 and graphics processing unit 370 in server 300.

With reference now to both FIG. 5 and FIG. 6, during operation, client device 100a will capture immersive video. In one embodiment, image capture unit 160 comprises side-by-side (SBS) capable HTTP live streaming (HLS) cameras configured to capture and stream immersive video (which can be 3D video) by generating video stream file 606 that comprises URLs to video segments that client device 100a uploads to server 300a. Thereafter, server 300a serves those video files at those URLs. In one embodiment, video stream file 606 is a Stream.m3u8 file.

Stream controller module 601 receives video stream file 606 from client device 100a. Client device 100a updates and transmits video stream file 606 periodically as it captures additional immersive video. Stream controller module 601 polls video stream file 606 every T seconds (for example, T=5 or 10) to update the list of video segments to be processed. Stream controller module 601 generates data structure 607 containing the URLs contained in video stream file 606 and provides data structure 607 to file download module 602.

File download module 602 downloads video files 608 that reside at the URLs (which in this example are served by server 300a) contained in data structure 607 and temporarily stores video files 608. In one embodiment, video files 608 are .ts files.

Stream converter module 603 obtains video files 608 from file download module 602 and transcodes video files 608 into video files 609, which have a different format than video files 608. In one embodiment, video files 609 are .mov files. Stream converter module 603 optionally utilizes a ported version of FFmpeg to perform the transcoding operation.

Spatial converter module 604 obtains video files 609 from stream converter module 603 and converts video files 609 from SBS or top-bottom (TB) format into video files 610. In one embodiment, video files 610 are MV-HEVC multitrack video files. Video files 610 optionally each contain video of N seconds or less in duration. For example, if N is 5 seconds, then each video file in video files 610 will have a duration of 5 seconds or less. If N is 6 seconds, then each video file in video files 610 will have a duration of 6 seconds or less.

Stream controller module 601 stores video files 610 and provides metadata for video files 610 to player composer module 605.

In one embodiment, player composer module 605 generates content for use by client devices (such as client devices 100b and 100c) where their operating system 210 is an operating system that is known by the trademarks “IOS” and “VISIONOS”. In this embodiment, player composer module 605 generates an AVPlayerItem object (which is an object that models the timing and presentation state of an asset during playback and is available within operating systems known by the trademarks “IOS” and “VISIONOS”) using an AVComposition object (which is an object that combines and arranges media from multiple assets into a single composite asset that can be played or processed and is available within operating systems known by the trademarks “IOS” and “VISIONOS”) to create playlist 611 (which in one embodiment is a single, continually lengthening native playlist) and transmits the playlist 611 to client devices 100b and 100c. Player composer module 605 optionally can use an AVQueuePlayer object (which is an object that plays a sequence of player items and is available within operating systems known by the trademarks “IOS” and “VISIONOS”) to handle clip transition issues. In another embodiment, player composer 605 generates content for use by client devices (such as client devices 100b and 100c) where their operating system 210 is a different operating system, in which case objects supported by the operating system and that perform similar functionality to those described above will be used instead.

Client devices 100b and 100c then can play video files 610 according to playlist 611 using client application 220 and display 180 within the client device.

Because video stream file 606 will be continually updated as client device 100a captures additional video, server application 420 will continually update data structure 608, video files 608, video files 609, video files 610, and playlist 611.

Thus, server application 420 transforms video files 608 into video files 609 and transforms video files 609 into video files 610, where video files 608 are of a first format (such as .ts), video files 609 are of a second format (such as .mov), and video files 610 are of a third format (such as MV-HEVC multitrack). Or considering the end result, it can be appreciated that server application 420 ultimately transforms video files 608 into video files 610, where video files 608 are of a first format (such as .ts) and video files 610 are of a second video format (such as MV-HEVC multitrack).

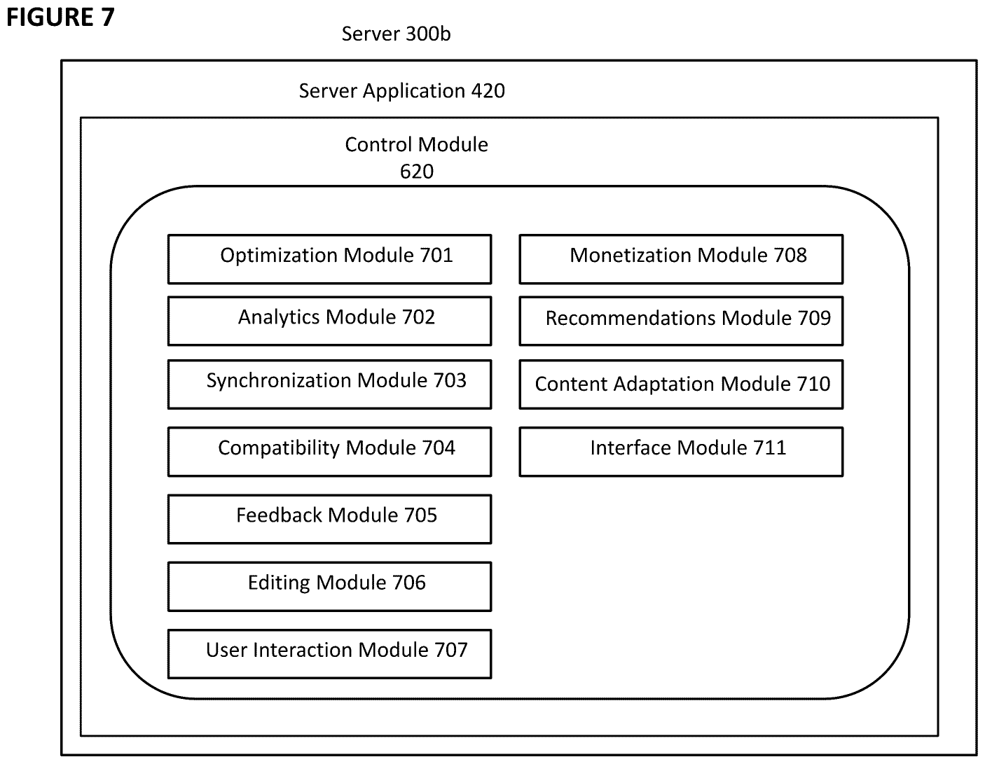

With reference to both FIG. 6 and FIG. 7, control module 620 optionally comprises one or more of the modules listed in Table No. 1 to provide the additional functionality specified in Table No. 1. Each of these modules comprises lines of software code executed by one or more of processing unit 310 and graphics processing unit 370 in server 300. Optionally, some or all of the functionality can instead be contained in client application 220 and executed by one or more of processing unit 110 and graphics processing unit 170 in client device 100.

TABLE NO. 1
OPTIONAL MODULES WITHIN CONTROL MODULE 620

| MODULE | FUNCTIONALITY PROVIDED |
|---|---|
| Optimization | This module dynamically adjusts streaming quality and |
| Module 701 | format based on network conditions and device capabilities |
| | to ensure seamless playback. |
| Analytics | This module monitors viewer engagement and |
| Module 702 | performance metrics to optimize content delivery and user |
| | experience. |
| Synchroniza- | This module allows for seamless playback of spatial |
| tion | streams across multiple devices, including AR/VR |
| Module 703 | headsets, tablets, and smartphones, ensuring a |
| | synchronized viewing experience; |
| Compat- | This module enables spatial content to be viewed on |
| ibility | various operating systems and devices without loss of |
| Module 704 | quality. |
| Feedback | This module allows users to provide real-time feedback |
| Module 705 | and ratings on the spatial content, which is then used to |
| | personalize future content recommendations. |
| Editing | This module allows creators to edit and enhance spatial |
| Module 706 | streams with special effects, annotations, and interactive |
| | elements. It also allows multiple creators to work together |
| | in real time to produce and refine spatial content. |
| User | This module allows viewers to interact with spatial content |
| Interaction | in real time, including selecting different viewpoints, |
| Module 707 | zooming in on specific details, and accessing additional |
| | information through augmented reality overlays. It also |
| | allows remote viewers to interact with event participants |
| | and other remote viewers through avatars and voice chat. |
| | It can provide a virtual classroom environment where |
| | instructors can deliver lessons through spatial streaming, |
| | allowing students to interact with 3D models and |
| | simulations in real-time. It can provide a training module |
| | that uses spatial streaming to provide immersive training |
| | scenarios for various industries, such as health care, |
| | engineering, and emergency response. It can provide a |
| | social platform where users can share and explore spatial |
| | streams, create virtual meetups or physical meetups, and |
| | interact with friends and influencers in immersive |
| | environments. It can provide a virtual reality space or |
| | facilitate physical interactions where users can host and |
| | attend social events, watch spatial content together, and |
| | engage in collaborative activities. |
| Monetization | This module allows content creators to monetize their |
| Module 708 | spatial content through subscriptions, pay-per-view, and |
| | advertising. |
| Recommend- | This module curates spatial content based on user |
| ations | preferences, viewing history, and behavior patterns. |
| Module 709 | |
| Content | This module personalizes the viewing experience by |
| Adaptation | adjusting the spatial stream to match the viewer's interests |
| Module 710 | and engagement levels. |
| Interface | This module allows spatial streams to be displayed on |
| Module 711 | smart mirrors, TVs, and VR headsets within the home. It |
| | provides a voice-controlled assistant that helps users |
| | navigate and control spatial content seamlessly across their |
| | smart home ecosystem. |

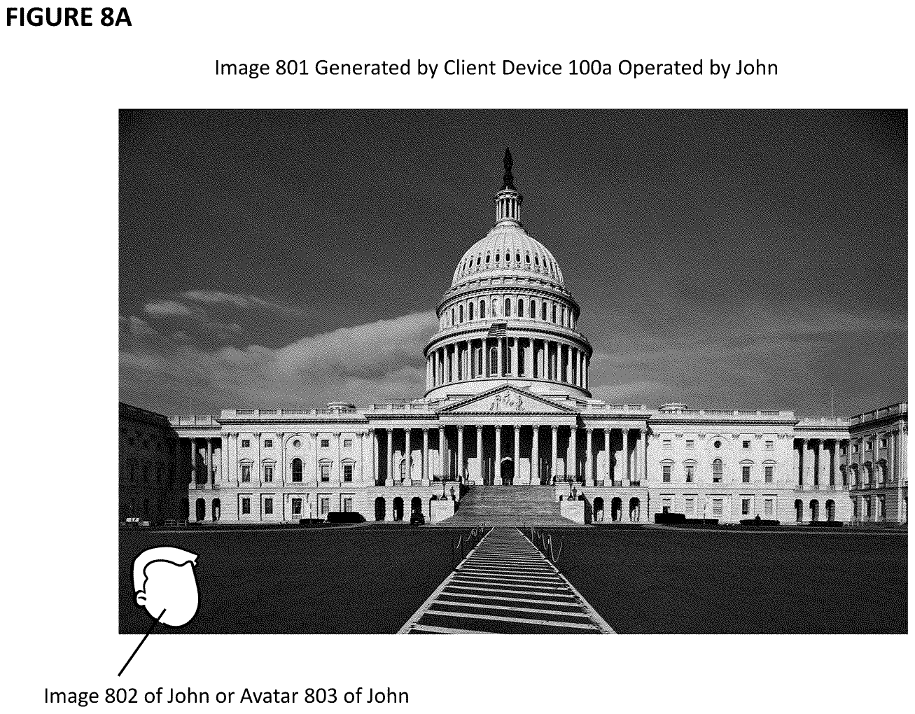

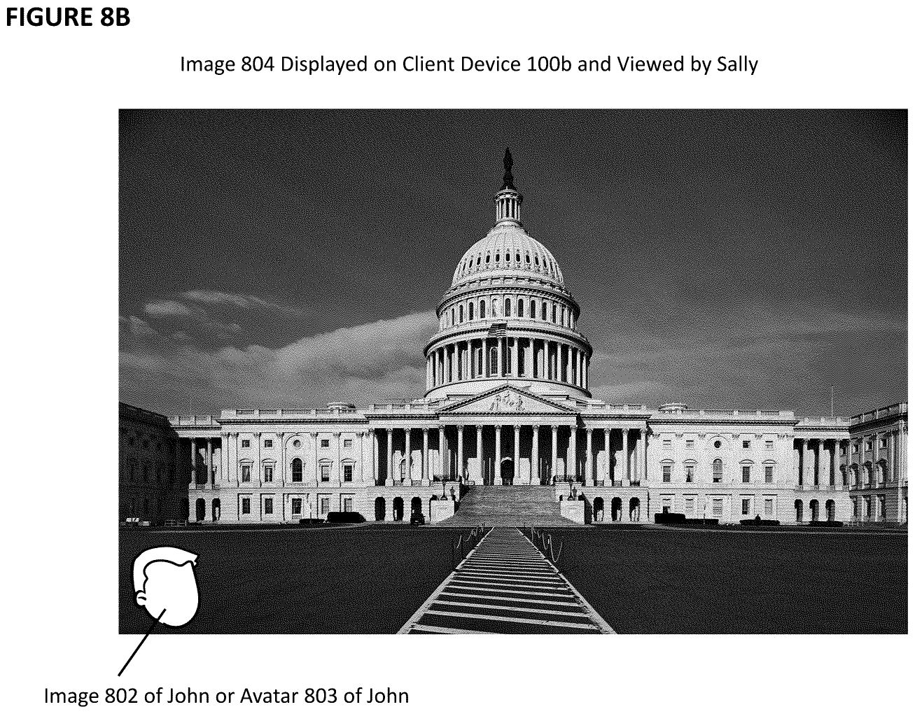

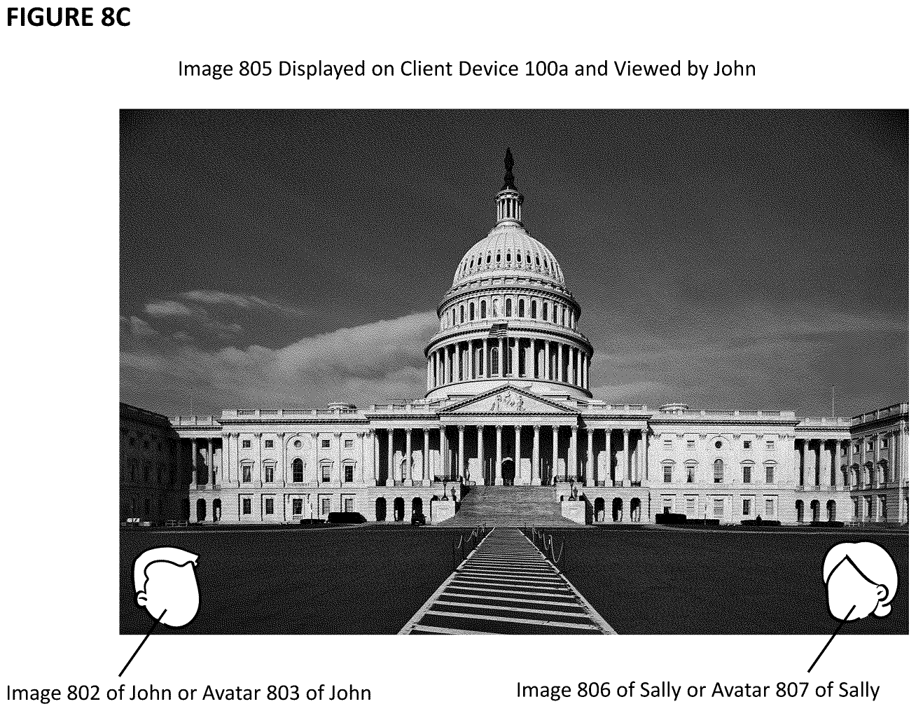

FIGS. 8A, 8B, and 8C depict an embodiment of an interactive immersive video experience that can be provided by user interaction module 707 using the embodiment of FIG. 6. This experience is intended to be interactive between the person who generates the content using client device 100a and one or more people who view the content using client devices 100b, 100c, or other instantiations of client device 100.

FIG. 8A depicts image 801 generated by client device 100a operated by John. Image 801 optionally is captured in real time from John's physical location. In this example, John is standing in front of the U.S. Capitol. Image 801 includes an image 802 of John captured by a camera or avatar 803 of John. Image 801 is streamed using the systems and methods previously described with reference to FIGS. 5-7. Image 801 can be a single photo or a frame in a video stream. FIG. 8B depicts image 804 received and displayed by client device 100b, which in this example is operated by Sally. Sally sees what John sees. Image 804 includes image 802 or avatar 803, enabling Sally to see John or his avatar. FIG. 8C depicts image 805. Client device 100a optionally can display image 801 from FIG. 8A or it can display image 805 in FIG. 8C, which here includes everything that John sees as well as image 802 or avatar 803 of John as well as image 806 of Sally (captured by a camera in client device 100b) or an avatar 807 of Sally. In this way, John and Sally share a fully interactive experience, and Sally can see the U.S. Capitol just as John can even though Sally is not physically in front of the U.S. Capitol.

The systems and methods described above provide enhanced video quality and interactivity for immersive experiences on client devices, overcoming the limitations of existing streaming technologies. They support live streaming, real-time conversion, and native playback, providing a robust solution for delivering immersive video content with low latency compared to the prior art.

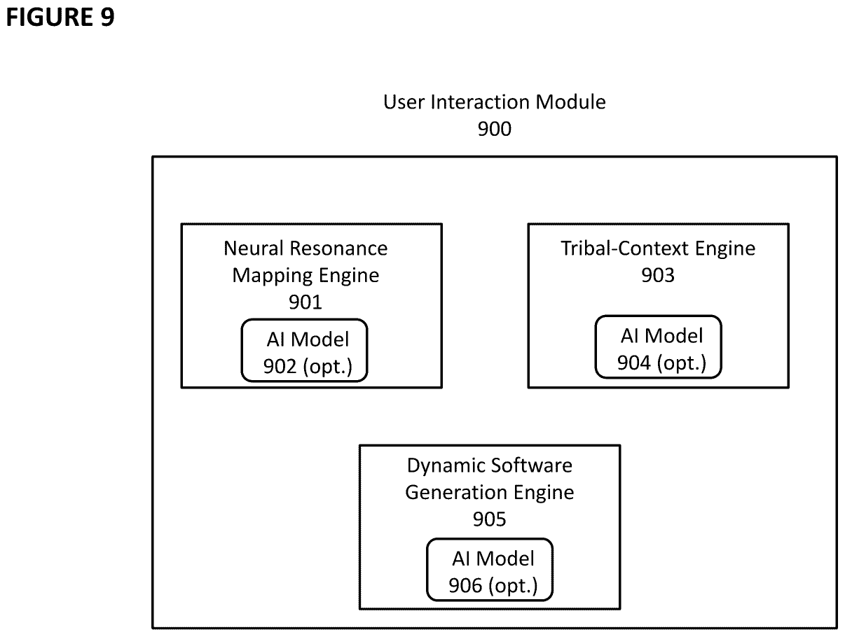

FIG. 9 depicts user interaction module 900, which is an example implementation of user interaction module 707. User interaction module 900 comprises lines of software code that can be executed by: (1) one or more of processing unit 310 and graphics processing unit 370 in server 300; (2) one or more of processing unit 110 and graphics processing unit 170 in client device 100; or (3) a combination of (1) and (2).

User interaction module 900 comprises neural resonance mapping engine 901, which optionally comprises AI model 902; tribal-context engine 903, which optionally comprises AI model 904; and dynamic software generation engine 905, which optionally comprises AI model 906.

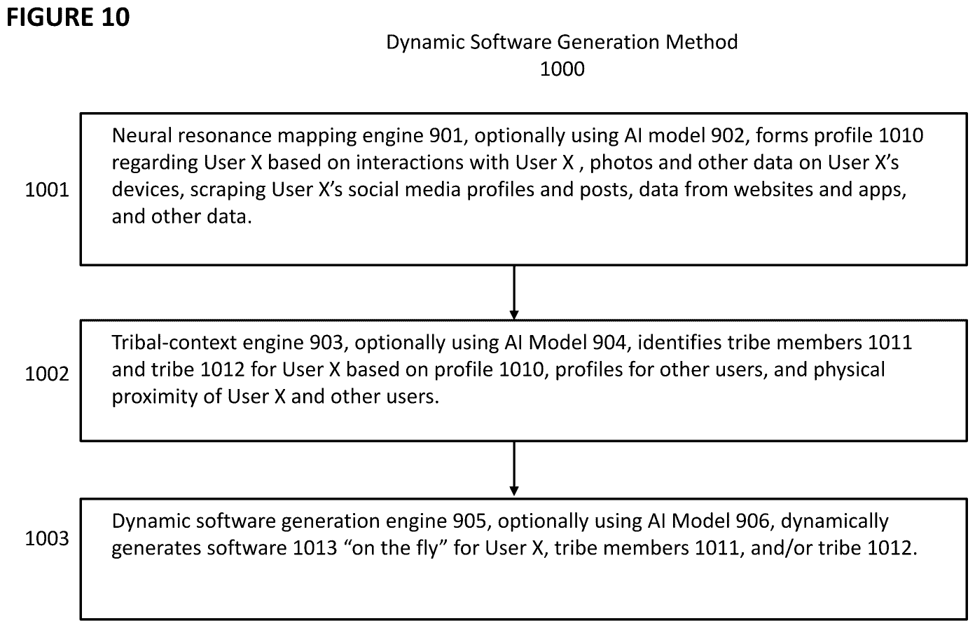

FIG. 10 depicts dynamic software generation method 1000 performed by user interaction module 707.

First, neural resonance mapping engine 901, optionally using AI model 902, forms profile 1010 regarding User X based on interactions with User X, photos and other data on User X's devices, scraping User X's social media profiles and posts, data from websites and apps, and other data (1001). The interactions can comprise questions posed by neural resonance mapping engine 901 to User X. Profile 1010 can comprise data reflecting User X's personality, interests, psychology, emotional intelligence, and other qualities.

In one embodiment, neural resonance mapping engine 901 employs one or more of the following:
Multi-modal profile extraction: A system that captures and processes user data across sensory, behavioral, linguistic, and social dimensions simultaneously
Temporal pattern recognition: Algorithms that identify not just static preferences but behavioral patterns over time
Contextual weighting system: A dynamic weighting mechanism that adjusts the importance of profile elements based on environmental context
Progressive disclosure protocol: A technical process for gradually increasing profile resolution through strategically sequenced micro-interactions
Resonance threshold triggers: Quantifiable metrics for when two profiles exceed statistical compatibility thresholds
Embedded feedback loops: Technical mechanisms that adjust resonance parameters based on actual interaction outcomes

Second, tribal-context engine 903, optionally using AI Model 904, identifies tribe members 1011 and tribes 1012 for User X based on profile 1010, profiles for other users, and physical proximity of User X and other users (1002). A tribe is a grouping of one or more users dynamically identified by the tribal-context engine through analysis of user data, wherein such groupings may serve as targets for automated software generation or other system functions. In various embodiments, the tribal-context engine may analyze any combination of relational parameters, contextual factors, proximity data, personality indicators, interest patterns, shared experiences, emotional intelligence markers, and natural aptitudes to identify tribes with high potential for meaningful connection. The system is designed to recognize patterns that predict when users will experience immediate rapport and lasting affinity. User X can then connect with tribe members 1011, either virtually or in person, and tribes 1012. Physical proximity to tribe members 1011 can be determined based on data from positioning unit 140 in the client device 100 operated by User X. This data can include GPS or GNSS data regarding the absolute location of client device 100 or data from an ultra-wideband chip in client device 100 indicating the close proximity of an ultra-wideband chip in another instantiation of client device 100. Optionally, User X receives an alert on client device 100 when User X is in close proximity to a tribe member 1011, which tribal-context engine 903 has already determined to be someone who has common characteristics, qualities, interests, or other criteria with User X, and client device 100 can provide instructions (e.g., directions on a map app on client device 100) to User X to find tribe member 1011.

In one example, proximity is determined using ultra-wideband chips in client devices 100, wherein a trigger event comprises detecting, via ultra-wideband ranging, that a first client device is within a threshold distance D of a second client device. In one embodiment, D is 10 centimeters. Optionally, the frequency of ultra-wideband scanning can be dynamically throttled based on motion state of client device 100 and the residual battery capacity of client device 100.

In one embodiment, User X and another tribe member are provided with directions to find one another in the physical world. For example, the respective client devices 100 operated by User X and the other tribe member 1011 can provide synchronized, real-time guidance through at least one of (i) audio earbuds/headphones, (ii) AR glasses, (iii) haptic wearables, (iv) neuro interface output, (v) a display, or (vi) other user interface, enabling virtual co-navigation of the matched users. Optionally, this synchronized guidance can be additionally delivered via a companion device such as an aerial drone, ground robot, telepresence unit, or other device, each maintaining a positional link to the matched users.

In one embodiment, profile 1010 and the profiles for other users are transformed into interest graph vectors and tribe members 1011 are identified for a tribe 1012 for User X based on those interest graph vectors. Optionally, the interest graph vectors are hashed on each respective client device 100 to encrypt the data, and server 300 or a client device 100 then compares the hashed interest graphics without having access to the unhashed-interest graph vectors. This will provide privacy and security for the personal data of each user.

Third, dynamic software generation engine 905, optionally using AI Model 906, dynamically generates software 1013 “on the fly” for User X, tribe members 1011, and/or tribes 1012 (1003). For example, software 1013 can: (1) provide a game for User X and tribe members 1011 in a particular tribe 1012 to play; (2) provide suggestions for activities for User X and tribe members 1011; (3) provide questions for User X and tribe members 1012 to discuss; (4) generate a meme that User X and tribe members 1012 will enjoy; and (5) take other actions that are selected based on profile 1010 for User X and the profiles for tribe members 1011 in the particular tribe 1012.

Optionally, dynamic software engine 905 can be instructed to optimize itself to attempt to generate software 1013 within a predetermined latency threshold, R, such that User X and tribe members 1011 can begin interacting with little delay. For example, R can be 2 or 3 seconds or any other number. In one embodiment, software 1013 streams immersive video, such as 8K resolution video, to client devices 100 for viewing by User X and tribe members 1011. In one embodiment, dynamic software engine 905 is executed by graphics processing unit 170 in client device 100 or graphics processing unit 380 in server 300 and assembles pre-compiled asset fragments into a Web XR bundle within the latency threshold R to generate software 103.

In certain embodiments, dynamic software engine 905 can include one or more of the following modules and characteristics:
Pre-compiled modular component architecture: A system of interchangeable software modules that can be rapidly assembled based on tribe profiles
Contextual compiler optimization: Techniques for prioritizing compilation tasks based on predicted user interaction patterns
Parallel processing pipeline: An architecture that distributes generation tasks across multiple cores with prioritized threading
Progressive rendering protocol: Methods for displaying initial interface elements while more complex components load
State prediction engine: Algorithms that pre-compute likely user states to accelerate software responsiveness
Resource allocation optimizer: Systems that dynamically allocate processing resources based on tribe size and complexity
Multi-phase deployment system: A technical approach that delivers the generated software in strategic phases within threshold T

In another embodiment, dynamic software engine 905 inserts a sponsor asset (such as an advertisement, video clip, audio clip, graphic, text, or other data) into software 103. Optionally, the sponsor asset is selected according to a bidding parameter associated with the user context. For example, if tribe 1012 is formed based on a mutual interest in car racing by tribe members 1011, then the sponsor asset can be selected according to a bidding parameter associating the various sponsor assets with car racing.

Optionally, dynamic software engine 905 can generate software 1013 more than once. For example, dynamic software engine 905 can generate software 1013 on a daily or weekly basis for tribe 1012, or it can do so periodically (e.g., once per day) as long as tribe 1012 engaged with software 1013 (for example, if tribe 1012 has a streak of N days in a row with engaging with software 1013).

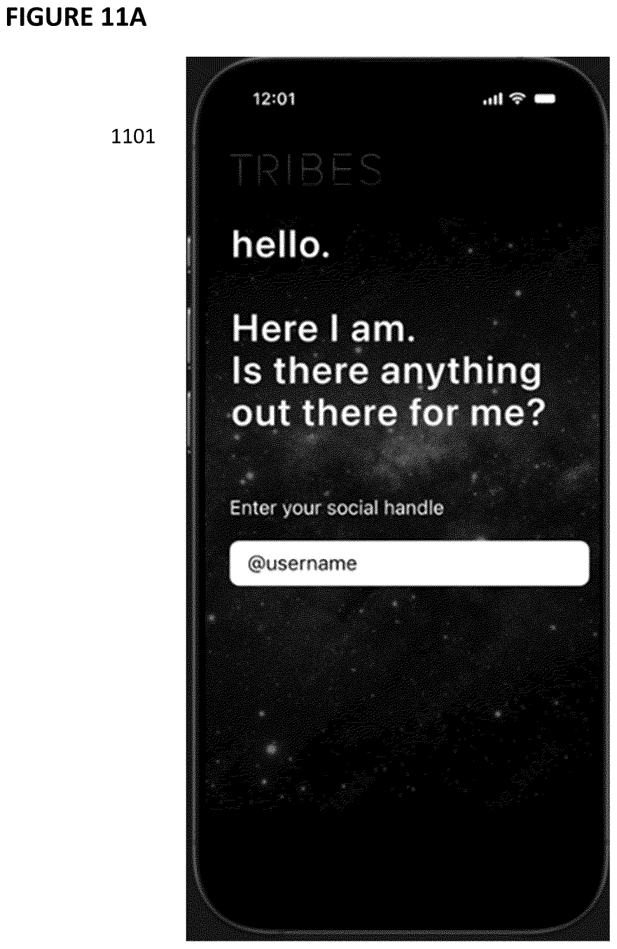

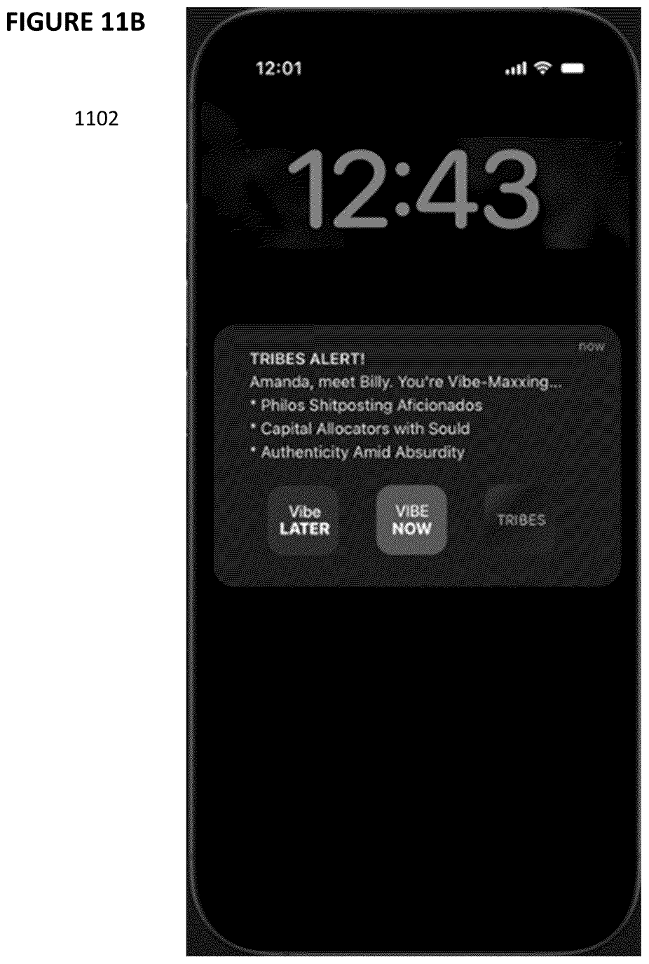

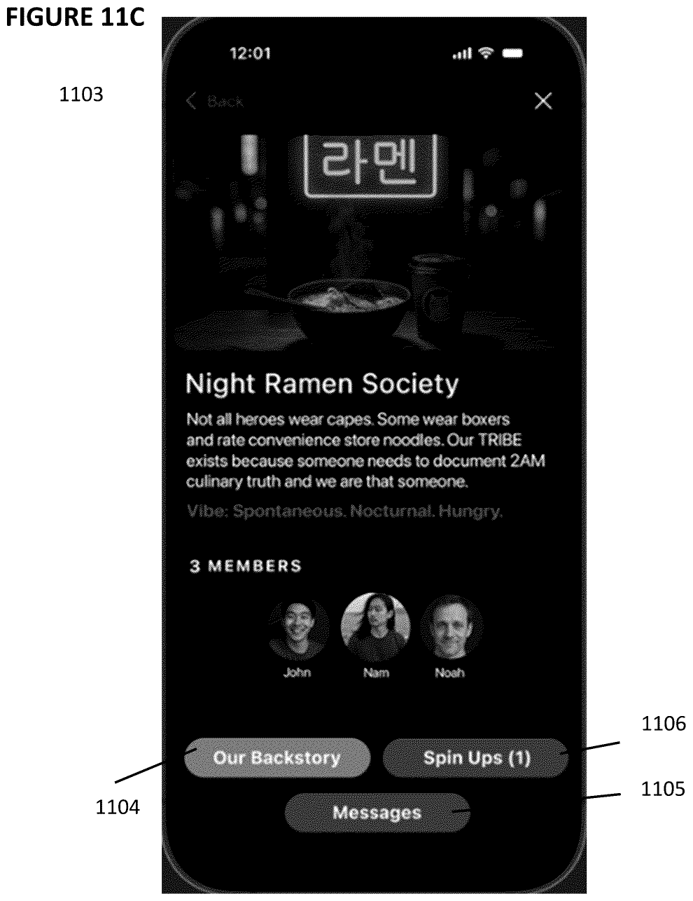

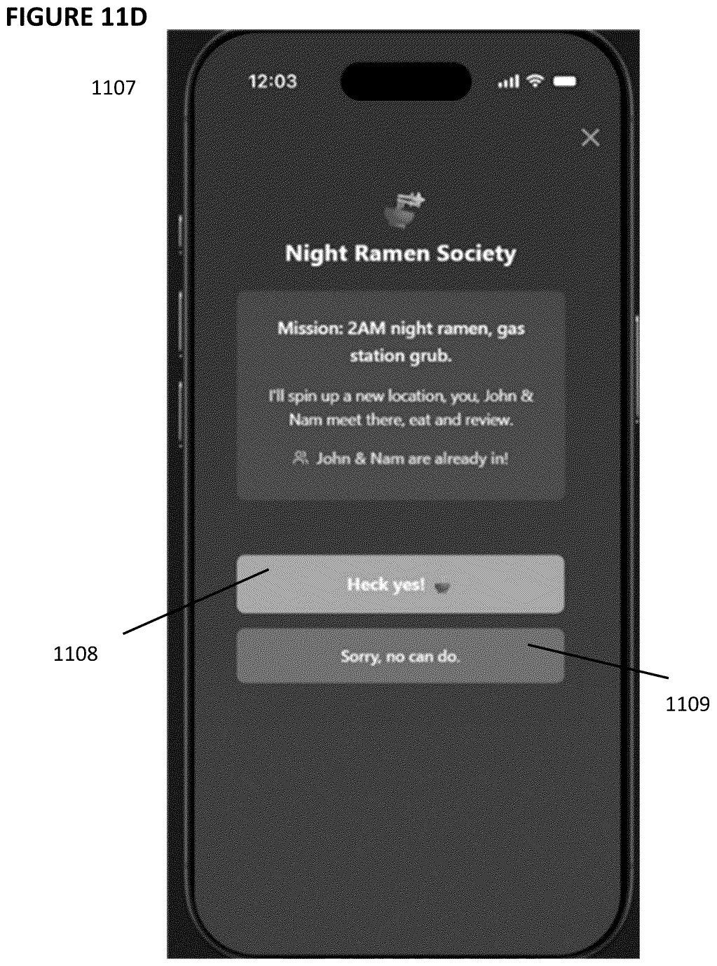

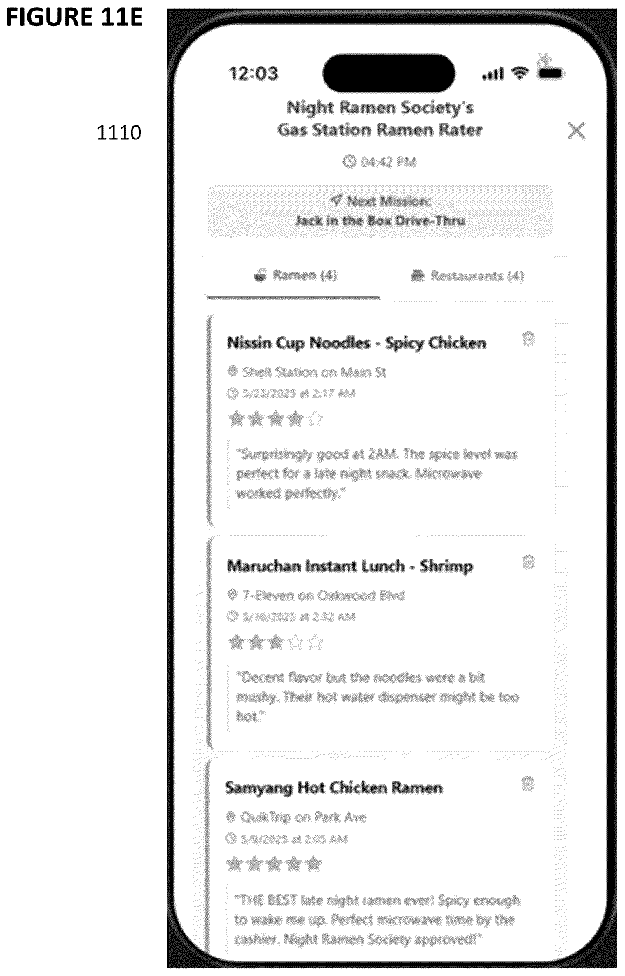

An example of one implementation of dynamic software generation method 1000 is the following: A method is performed comprising automated generation and deployment of context aware mini applications (which can be referred to as “Spin Ups”) within a latency threshold R, triggered by ultra-wideband proximity detection and interest graph matching among a plurality of individuals, optionally streaming spatial video up to 8K resolution to mixed reality devices. FIGS. 11A, 11B, 11C, 11D, and 11E contain example screenshots on client device 100 (which in this example is a mobile phone) during dynamic software generation method 1000.

FIG. 11A depicts screenshot 1101, which is an example screen by which User X indicates interest in meeting tribe members 1011 and finding tribes 1012.

FIG. 11B depicts screenshot 1102, which is an example notification to User X of a tribe member 1011 in close proximity that tribal-context engine 903 has determined to be someone with whom User X will likely form a strong connection.

FIG. 11C depicts screenshot 1103, which is an example screen that signifies the formation of tribe 1012 for User X and tribe members 1011 and provides functionality for them. In this example, tribe 1012 is the “Night Ramen Society” and was formed because User X and tribe members 1011 all enjoy eating ramen late at night. Button 1104, when selected, will cause information to be shown as to what User X and tribe members 1011 have in common. Button 1105, when selected, will enable User X and tribe members 1011 to exchange messages. Button 1106, when selected, will cause dynamic software generation engine 905 to generate an activity for tribe 101.

FIG. 11D depicts screenshot 1107, which is an example screen for an activity generated by dynamic software generation engine 905. In this example, dynamic software generation engine 905 suggests that tribe 1012 go to eat ramen at 2 a.m.; if two or more tribe members 1011 select button 1108 (indicating a desire to participate), then dynamic software generation engine 905 will provide instructions on where to go. If all or all but one of the tribe members 1011 (including User X) selects button 1109 (indicating a desire to not participate), or if no more than one selection of button 1108 occurs within a predetermined time period (e.g., 30 minutes) then dynamic software generation engine 905 will take no further action.

FIG. 11E depicts screenshot 1110, which is an example screen that follows screenshot 1107 of FIG. 11D when more than one tribe member 1011 has selected button 1108 to indicate a desire to participate in the activity. Dynamic software generation engine 905 here provides a plurality of suggestions for places nearby where the group can have ramen at night.

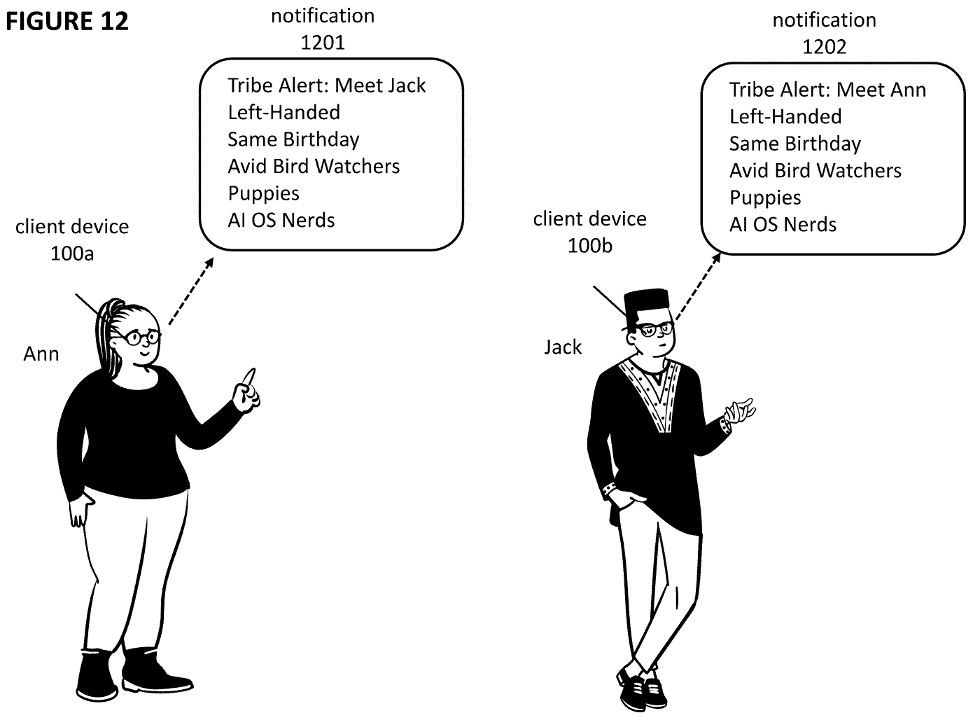

FIG. 12 depicts an example of step 1002 in dynamic software generation method 1000 in FIG. 10 in a situation involving two users (Ann and Jack) who are operating client devices 100a and 100b, respectively, where client devices 100a and 100b are smart glasses. Based on the proximity of client devices 100a and 100b and the profiles 1010 (not shown) already generated for Ann and Jack, tribal-context engine 903 generates notification 1201 for Ann and notification 1202 for Jack. Notifications 1201 and 1202 provide an explanation of why Ann and Jack are likely to connect in a meaningful way—both are left handed, share the same birthday, are avid bird watchers, like puppies, and are AI OS nerds. Thereafter, tribal-context engine 903 can form tribe 1012 for Ann and Jack. Optionally, other tribe members 1011 can be added to tribe 1012.

The improvements of the embodiments for immersive video over the prior art systems include the following: Technical Innovation: Near-Instant Loading of High-Resolution Immersive Content; Comparative Performance Analysis: Immersive Video Loading; Technical Significance of Immersive Video Loading Optimization; Cross-Format Compatibility and Universal Application; Virtual Reality and Augmented Reality Device-Agnostic Implementation; Comprehensive Coverage Across Field-of-View and Resolution Ranges; Native Quality Preservation with Zero Perceptible Loss; and True Streaming Capability vs. Download-First Approaches. Prior art systems force a choice between (1) waiting 30-45 minutes to download the complete file to get this native quality, and (2) heavily compressing the content (reducing resolution, bitrate, color depth, etc.) to enable streaming, which results in significantly degraded visual quality. By contrast, certain embodiments preserve the full resolution, bit depth, color accuracy, and all other quality parameters of these platform-specific formats while still enabling near-instant streaming.

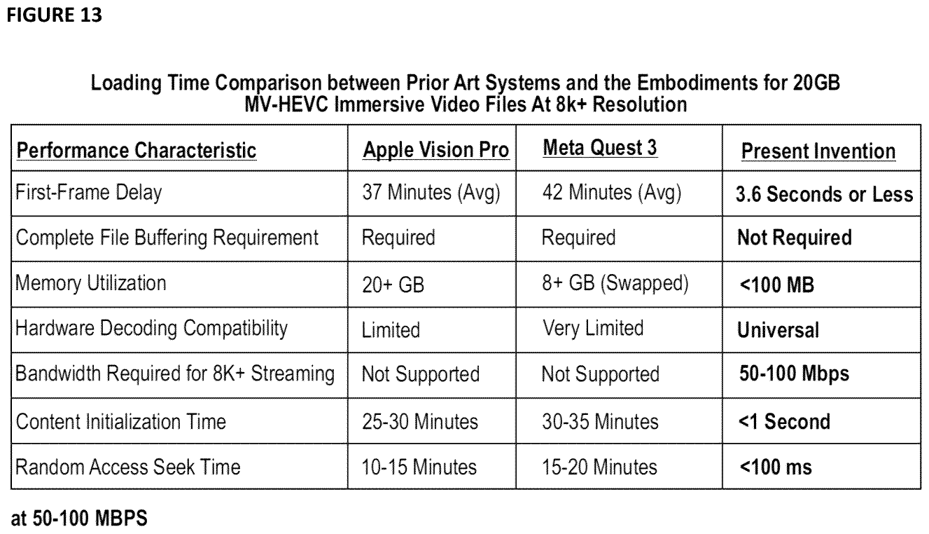

FIG. 13 depicts a loading time comparison for 20 GB MV-HEVC immersive video files at 8K+ resolution. The figure presents a table comparing the performance characteristics of prior art systems (Apple Vision Pro and Meta Quest 3) against the present embodiments. As shown in FIG. 13, prior art systems require 37-42 minutes before displaying the first frame of content, while the embodiments achieve first-frame display in 3.6 seconds or less—an improvement factor exceeding 500×. FIG. 13 also compares additional performance metrics including memory utilization, hardware decoding compatibility, bandwidth requirements, content initialization time, and random access seek time, demonstrating the superior performance of the present embodiment across all measured characteristics.

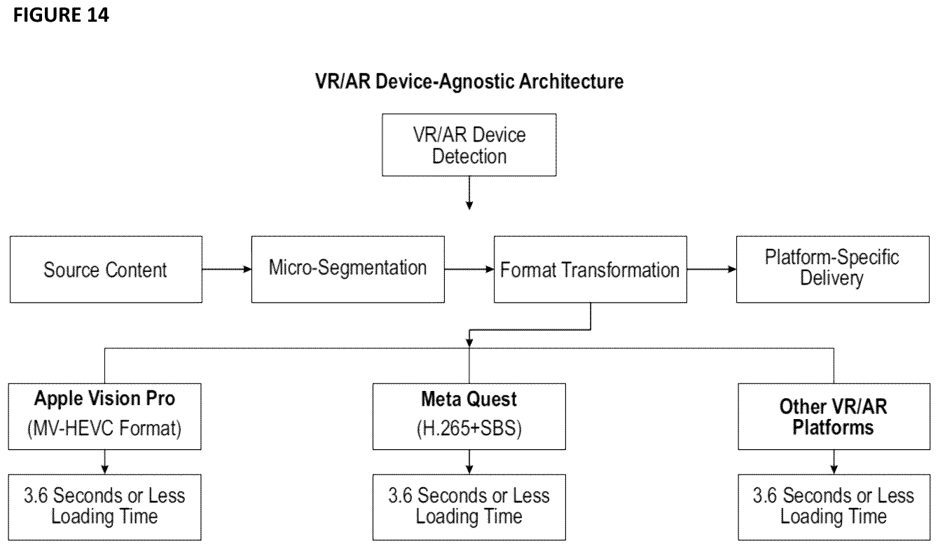

FIG. 14 depicts the VR/AR device-agnostic architecture of the present embodiments. The figure presents a flow diagram showing how source content is processed through micro-segmentation and format transformation before being delivered to different VR/AR platforms including Apple Vision Pro. Meta Quest, and other VR/AR platforms. As shown in FIG. 14. the architecture maintains consistent 3.6-second loading times across all platforms regardless of their native format requirements, demonstrating the universal applicability of the embodiments across the entire VR/AR ecosystem.

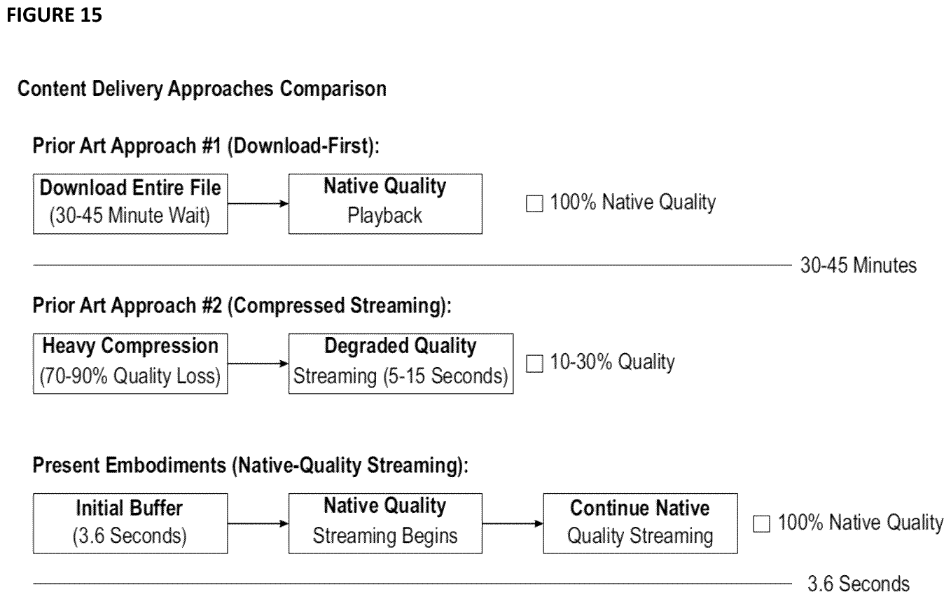

FIG. 15 depicts the fundamental difference between the approach of the embodiments and prior art systems for delivering high-quality immersive content. The figure presents a flow diagram contrasting two approaches: (1) the prior art approach, which requires either a 30-45 minute complete download before playback at native quality, or streaming with severe quality degradation through heavy compression; and (2) the approach of the embodiments, which enable true streaming at native quality with only a 3.6-second initial buffer before beginning playback. This diagram illustrates how the present embodiments eliminate the traditional forced choice between quality and immediacy, enabling applications such as telepresence and live broadcasting of high-quality immersive content that were previously impossible without significant quality compromise.

Embodiments, materials, processes, and numerical examples described above are exemplary only, and should not be deemed to limit the claims.

1. A server comprising:
memory storing a server application; and
a processing unit to execute the server application to receive a video stream file from a first client device, download a first set of video files of a first format using the video stream file, transforming the first set of video files into a second set of video files of a second format, and transmitting a playlist comprising URLs to the second set of video files to a second client device.

2. The server of claim 1, wherein the first format is .ts.

3. The server of claim 2, wherein the second format is MV-HEVC multitrack.

4. The server of claim 1, wherein the video stream file is a Stream.m3u8 file.

5. The server of claim 1, wherein the first set of video files comprises immersive video and the second set of video files comprises immersive video.

6. The server of claim 1, wherein the first set of video files comprises an image or avatar of a user of the first client device.

7. The server of claim 1, wherein each file in the second set of video files contains video of duration of t seconds or less.

8. A method comprising:
receiving, by a server, a video stream file from a first client device; downloading, by the server, a first set of video files of a first format using the video stream file;
transforming, by the server, the first set of video files into a second set of video files of a second format; and
transmitting, by the server, a playlist comprising URLs to the second set of video files to a second client device.

9. The method of claim 8, wherein the first format is .ts.

10. The method of claim 9, wherein the second format is MV-HEVC multitrack.

11. The method of claim 8, wherein the video stream file is a Stream.m3u8 file

12. The method of claim 8, wherein the first set of video files comprise immersive video and the second set of video files comprise immersive video.

13. The method of claim 8, comprising:
receiving, by the server, an updated video stream file from the first client device.

14. The method of claim 13, comprising:
transmitting, by the server, an updated playlist comprising URLs to an updated second set of video files to a second client device.

15. The method of claim 8, comprising:
displaying, on the second client device, the second set of video files using the playlist.

16. The method of claim 15, wherein the second set of video files comprises an image or avatar of a user of the first client device.

17. The method of claim 16, comprising:
displaying, on the first client device, an image or avatar of a user of the second client device.

18. The method of claim 8, wherein each file in the second set of video files contains video of duration of N seconds or less, where N is an integer.

19. A dynamic software generation method, comprising:
forming a first profile for a first user;
forming a second profile for a second user;
generating a notification on a first client device operated by the first user in response to the first profile, the second profile, and a distance between the first client device and a second client device operated by the second user;
generating a notification on the second client device in response to the first profile, the second profile, and a distance between the first client device and the second client device;
forming a group comprising the first user and the second user; and
generating software code for an activity for the group.

20. The method of claim 19, wherein the first client device is a mobile phone and the second client device is a mobile phone.

21. The method of claim 19, wherein the first client device is smart glasses and the second client device is smart glasses.
